(19) United States
(12) Patent Application Publication
(10) Pub. No.: US 2005/0042011 A1
(43) Pub. Date: Feb. 24, 2005

(54) Paper discharging apparatus for a printer

(75) Inventors: Jae-hee Han, Suwon-si (KR); Hwang-hyeon Gha, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/827,358

(22) Filed: Apr. 20, 2004

(30) Foreign Application Priority Data
Aug. 21, 2003 (KR) 2003-58068

(51) Int. Cl. B41J 32/00

(52) U.S. Cl. 400/283

(57) ABSTRACT

A paper discharging apparatus of a printer, including a paper guide member which is movable between first and second positions to stack papers discharged from the paper outlet, on different positions with respect to discharging directions, and a driving unit to selectively move the paper guide member between the first and the second positions.

### CROSS-REFERENCE TO RELATED APPLICATIONS

This application claims the benefit of Korean Application No. 2003-58068, filed Aug. 21, 2003, in the Korean Intellectual Property Office, the disclosure of which is incorporated herein by reference.

### BACKGROUND OF THE INVENTION

1. Field of the Invention

The present invention relates to a printer, and more particularly, to a paper discharging apparatus of a printer, to discharge papers to an outside of the printer after printing.

2. Description of the Related Art

General printing machines such as copiers and color laser printers include a paper supplying unit to supply papers to a printer body, a developing unit to form an image on the paper picked up sheet by sheet at the paper supplying unit, a fusing unit to fuse the image onto the paper, and a discharging apparatus to discharge the paper passed through the fusing unit to the outside of the printer body, and a discharged paper tray to stack the discharged paper, the discharging apparatus includes a paper discharging roller and a backup roller which rotates in contact with the paper discharging roller. Therefore, a printer, which is only for an A4-size paper or a letter paper, usually has a simple structure including the paper discharging roller and the backup roller without any other functions.

However, a printer for an A3-size paper has the function of offset printing. Specifically, the offset printing function facilitates sorting documents by varying stacking positions of the documents according to the type thereof.

For the general conventional offset printing, the paper is moved substantially perpendicular to a discharging direction, that is, right and left, to simplify sorting of the printed material. In other words, a plurality of paper sheets are stacked by repeating the processes of discharging of papers of a first document to the left side, and discharging the papers of the next document to the right side.

However, according to the above paper discharging method, the printer should be wide enough to stack in alternate positions. This goes against the current trend of downsizing and lightening printing machines. Thus, the above paper discharging method has disadvantages.

### SUMMARY OF THE INVENTION

Accordingly, it is an aspect of the present invention to overcome the above-mentioned problems of the related art.

Accordingly, it is another aspect of the present invention to provide a paper discharging apparatus with an improved structure so that papers can be discharged and be sorted as demanded, without enlarging a size of a printer.

Additional aspects and/or advantages of the invention will be set forth in part in the description which follows and, in part, will be obvious from the description, or may be learned by practice of the invention.

The foregoing and/or other aspects are achieved by providing a paper discharging apparatus to discharge a paper including a body having a paper outlet in which an image is printed to the paper outlet the paper discharging apparatus including a paper guide member which is movably positioned between first and second positions to stack papers discharged from the paper outlet, on different positions with respect to a discharging direction of the paper, and a driving unit to selectively move the paper guide member between the first and second positions.

The paper guide member is pivotably mounted at the paper outlet. When the paper guide member is in the first position, the papers drop from the paper outlet without being guided by the paper guide mechanism. When the paper guide member is in the second position, a lower surface of the paper contacts the paper guide member and places the paper further than in the first position from the paper outlet. Here, the paper guide member can be moved by the driving unit, being mounted to slide into and out of the paper outlet in a paper discharging direction.

The paper guide member may include a pivot shaft pivotably supported by the paper outlet, a guide panel supported by the pivot shaft being exposed to an outside of the paper outlet, and contacted with the lower surface of the paper in the second position, and a driving panel extended in a direction perpendicular to the guide panel to pivot in relation to the movement of the driving unit being interfered by the driving unit. The guide panel and the driving panel may be integrally formed.

In addition, a sorting position of the discharged paper is determined according to a length of the guide panel in a paper discharging direction. The guide panel is formed in a symmetric pair.

Further, the guide panel has a centroid such that the guide panel returns to the original position by pivotally moving due to its own weight, in the second position, when the driving unit is turned off.

The driving unit includes a solenoid to forcibly move the paper guide member to the first and the second positions by interfering with a driving panel of the paper guide member by switching on/off.

### BRIEF DESCRIPTION OF THE DRAWINGS

These and/or other aspects and advantages of the invention will become apparent and more readily appreciated from the following description of the embodiment, taken in conjunction with the accompanying drawings of which:

FIG. 1 is a perspective view of a printer to use a paper discharging apparatus according to an embodiment of the present invention;

FIG. 2 is a schematic perspective view of the paper discharging apparatus shown in FIG. 1; and

FIGS. 3 and 4 are schematic sectional views illustrating the operation of the paper discharging apparatus of FIG. 2.

### DETAILED DESCRIPTION OF THE PREFERRED EMBODIMENTS

Reference will now be made in detail to the embodiment of the present invention, an example of which is illustrated in the accompanying drawings, wherein like reference numerals refer to the like elements throughout. The embodiment is described below to explain the present invention by referring to the figures.

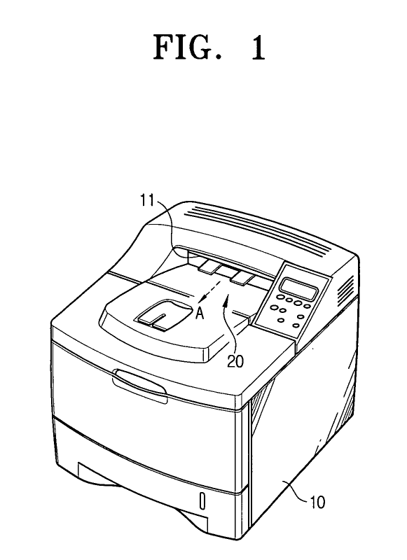

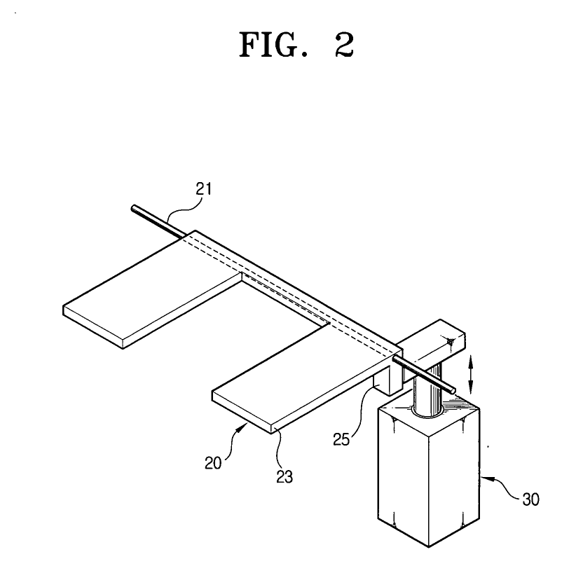

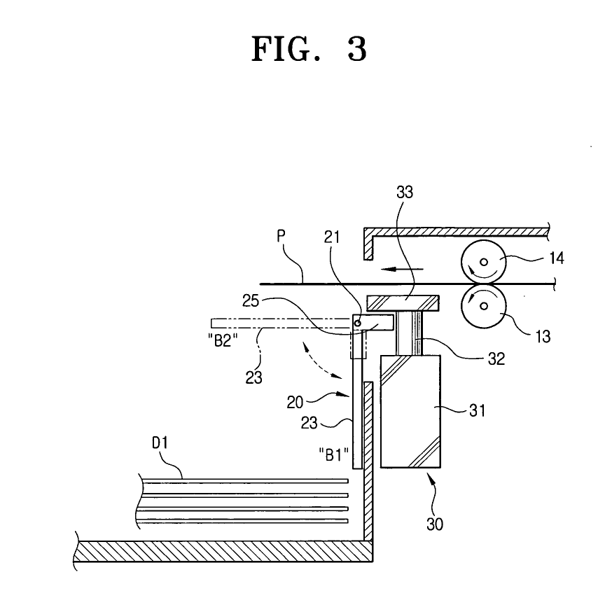

Referring to FIG. 1, a paper discharging apparatus according to an embodiment of the present invention sorts papers which are discharged through a paper outlet 11 of a printer body 10, by placing the papers on positions of different distances in a discharging direction A according to the type of document. The paper discharging apparatus includes a paper guide member 20 movably disposed between a first position B1 (FIG. 3) and a second position B2 (FIG. 3) of the paper outlet 11 of the printer body 10, and a driving unit 30 to selectively move the paper guide member 20 to the first and second positions B1 and B2, as shown in FIGS. 2 and 3.

The paper outlet 11 has a discharging roller 13 (FIG. 3) to forcibly discharge a paper P in which an image is developed, and a backup roller 14 rotating in contact with the discharging roller 13.

The guide member 20 includes a pivot shaft 21 mounted in the paper outlet 11, a guide panel 23 and a driving panel 25 which are connected to each other so as to pivot with respect to the pivot shaft 21. The guide panel 23 is connected to the pivot shaft 21 to be exposed to the outside of the paper outlet 11. The guide panel 23 is horizontally mounted to the discharging direction A of the paper P in the second position B2. Accordingly, the guide panel 23 guides a transfer of the paper P, contacting with a lower surface of the paper P in the second position B2.

The driving panel 25 is perpendicularly connected to the guide panel 23, with respect to the pivot shaft 21. The driving panel 25 pivots in relation to the movement of the driving unit 30 as the driving unit 30 is driven. Accordingly, the guide panel 23 connected to the driving panel 25 is simultaneously pivoted as the driving panel 25 is driven.

The guide panel 23 has a longer length than the driving panel 25 in the direction A, and a center of mass with respect to the pivot shaft 21 is in the guide panel 23. As a result, when force on the driving unit 30 is removed in the second position B2, the guide member 20 pivots, falling to the first position B1.

The driving unit 30 may also be a solenoid to interfere with the driving panel 25 by switching on/off operations, and moving the guide member 20 to the first and the second positions B1 and B2. Hereinafter, the driving unit 30 is referred to as the solenoid 30. The solenoid 30 includes a body 31, an operation unit 32 to move up and down with respect to the body 31, and a contact unit 33 connected to an end of the operation unit 32. The contact unit 33 moves the driving panel 25 while being contacted therewith.

The operation of the paper discharging apparatus having the above structure according to the embodiment of the present invention will be described as follows.

When the printer is networked with a plurality of personal computers (not shown), a plurality of users may give a printing command relating to different documents at similar times. Then, first, the printer performs printing work in the commanded order. Papers D1 in which a first-commanded document are printed are stacked near the paper outlet 11 since the paper guide member 20 is disposed in the first position B1, as shown in FIG. 3.

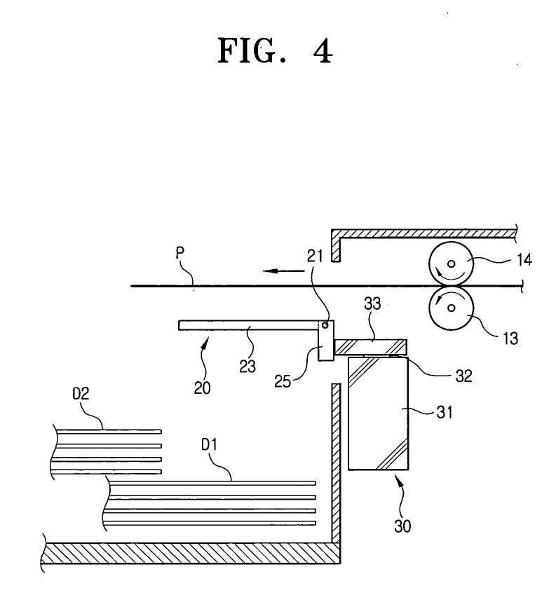

After the first-commanded document is completely printed, the solenoid 30 is turned on to move down the operation unit 32. Then, the contact unit 33 draws down the driving panel 25, thereby pivoting the driving panel 25. The guide panel 23 also pivots moving together with the driving panel 25, to the second position B2, as shown in FIG. 4. In this state, papers D2 on which a second-commanded document is printed are discharged. The discharged papers D2 are guided by the guide panel 23, and then stacked further than the first discharged papers D1 with respect to the paper outlet 11. That is, the papers D2 on which a second-commanded document D2 is printed are guided further than the papers D1 in the direction A, and are stacked. Thus, the papers of different documents can be properly sorted by varying the positions of the paper guide member 20 in the discharging direction A. Therefore, the width of the printer does not have to be increased to sort different documents by alternately discharging the documents right and left. That is, a compact-sized printer can be realized.

When the second-commanded document is completely printed, the solenoid 30 is turned off. Then, the contact unit 33 of the solenoid 30 rises to the original position, as shown in FIG. 3. The paper guide member 20 pivots counterclockwise to the first position B1, falling by the weight of the guide panel 23.

As described above, the discharged papers D1 and D2 can be sorted and stacked according to the different documents, by repeatedly moving the paper guide member 20 to the first and the second positions B1 and B2. In addition, stacked positions of the documents are determined in proportion to a length of the guide panel 23. Therefore, sorting positions of the discharged papers can be determined by controlling the length of the guide panel 23.

Furthermore, the above-structured paper discharging apparatus can be employed in other image forming devices such as a facsimile or a copier, in a similar manner.

Furthermore, a cam member having a predetermined cam side surface can be employed to repeatedly move the paper guide member 20 to the first and the second positions B1 and B2, as another embodiment of the present invention, although the cam member is not shown.

Alternatively, instead of the pivotable guide member 20, a sliding guide member which slides into and out of the paper outlet 11 may be employed in order to stack the papers on different positions according to the document, by selectively sliding the guide member in the discharging direction A.

According to the described discharging apparatus of the printer of the present invention, printing papers can be sorted according to the document without enlarging the width of the printer, thereby providing a small-size printer.

Although an embodiment of the present invention has been shown and described, it would be appreciated by those skilled in the art that changes may be made in this embodiment without departing from the principles and spirit of the invention, the scope of which is defined in the claims and their equivalents.

1. A paper discharging apparatus of an image forming apparatus to discharge papers, including a body having a paper outlet, an image being printed on the papers at the paper outlet, the paper discharging apparatus comprising:
a paper guide member which is movably disposed between first and second positions with respect to a paper discharging direction of the papers to stack the papers discharged from the paper outlet; and
a driving unit to selectively move the paper guide member between the first and second positions.

2. The discharging apparatus of claim 1, wherein the paper guide member is pivotably mounted at the paper outlet, when the paper guide member is in the first position the papers drop to a first placing position from the paper outlet without being guided by the paper guide member, and when the paper guide member is in the second position, a lower surface of each of the papers contacts the paper guide member to place the papers at a second placing position which is further than the first placing position from the paper outlet.

3. The discharging apparatus of claim 2, wherein the paper guide member comprises:
a pivot shaft pivotably supported by the paper outlet;
a guide panel supported by the pivot shaft being exposed to an outside of the paper outlet, and contacted with the lower surface of the papers in the second position; and
a driving panel extended in a direction perpendicular to the guide panel to pivot in relation to the movement of the driving unit being interfered by the driving unit.

4. The discharging apparatus of claim 1, wherein the first and second placing positions of the discharged papers are determined according to a length of the paper guide member I in the paper discharging direction.

5. The discharging apparatus of claim 3, wherein the guide panel comprises a pair of panels formed symmetrically.

6. The discharging apparatus of claim 3, wherein the guide panel moves to the first position by pivotingly falling from the second position due to a weight thereof, when the driving unit is turned off.

7. The discharging apparatus of claim 1, wherein the paper guide member comprises a driving panel and the driving unit comprises a solenoid to switch on/off to forcibly move the paper guide member to the first and second positions by interfering with the driving panel of the paper guide member.

8. An apparatus to discharge papers in a discharge direction, comprising:
a guide disposed between first and second guide positions to respectively stack the discharged papers in first and second stacking positions, the first and second stacking positions being disposed relative to each other along the discharge direction.

9. The apparatus of claim 8, further comprising a driver to selectively move the guide between the first and second guide positions.

10. The apparatus of claim 9, wherein the guide comprises:
a shaft;
a first panel extending from the shaft to guide the discharged papers when the guide is in the first guide position; and
a second panel extending from the shaft to be moved by the driver.

11. The apparatus of claim 10, wherein the first panel has a greater length in a direction perpendicular to the shaft than the second panel, and the first panel moves due to a weight thereof when a force from the driver on the second panel is removed.

12. The apparatus of claim 10, wherein the discharged papers do not contact the guide when the guide is in the second guide position.

13. The apparatus of claim 9, wherein the driver is a solenoid.

14. An image forming apparatus, comprising:
a body defining a paper outlet to discharge papers having images formed thereon in a discharge direction; and
a discharge apparatus to sort the discharged papers, comprising:
a guide disposed between first and second guide positions to respectively stack the discharged papers in first and second stacking positions, the first and second stacking positions being disposed relative to each other along the discharge direction, and
a driver to selectively move the guide between the first and second guide positions.

15. An apparatus to discharge papers in a discharge direction, comprising:
stacking means for stacking the discharged papers in first and second stacking positions, disposed between first and second guide positions, the first and second stacking positions being disposed relative to each other along the discharge direction.

16. The apparatus of claim 15, further comprising drive means for selectively moving the stacking means between the first and second guide positions.

17. The apparatus of claim 15, wherein the stacking means comprises:
a shaft;
a first panel extending from the shaft to guide the discharged papers when the stacking means is in the first guide position; and
a second panel extending from the shaft to be moved by the drive means.

18. An image forming apparatus, comprising:
discharging means for discharging papers having images formed thereon in a discharge direction; and
sorting means for sorting the discharged papers, comprising:
stacking means for stacking the discharged papers in first and second stacking positions, the first and second stacking positions being disposed relative to each other along the discharge direction, and
moving means for selectively moving the stacking means between first and second guide positions to respectively stack the discharged papers in the first and second stacking positions.
